(19) United States
(12) Patent Application Publication
(10) Pub. No.: US 2025/0367693 A1
(43) Pub. Date: Dec. 4, 2025

(54) VALVE STRUCTURE AND ACCUMULATOR SPRAYER COMPRISING VALVE STRUCTURE

(71) Applicant: CANYON CORPORATION, Tokyo (JP)

(72) Inventor: Mitsuaki SHAZUKI, Sanyo Onoda-shi, Yamaguchi (JP)

(21) Appl. No.: 18/875,896

(22) PCT Filed: Apr. 25, 2023
(86) PCT No.: PCT/JP2023/016209

§ 371 Date: Dec. 17, 2024

(30) Foreign Application Priority Data
Jun. 20, 2022 (JP) 2022-098628

(51) Int. Cl. B05B 11/10

(52) U.S. Cl. CPC B05B 11/1021; B05B 11/1073

(57) ABSTRACT

A valve structure A of an accumulator sprayer X provided with a cylinder body portion B having a main cylinder portion B1 and a sub-cylinder portion B2, and a cover portion C that is attached to cover the cylinder body portion B, wherein; the accumulator sprayer X sucks up liquid in a container J through a first valve FV to the main cylinder portion B1, pressurizes the liquid and spraying the liquid from a nozzle portion F when the pressure of the liquid reaches a certain pressure; and the valve structure A comprises a spring portion and a valve piston portion, wherein the valve piston portion is provided with a spring attaching portion, the spring portion is attached to the spring attaching portion, the spring portion presses the valve piston portion in vertical direction, and the spring portion has higher rigidity than the valve piston portion.

### TECHNICAL FIELD

The present invention relates to a valve structure of an accumulator sprayer and an accumulator sprayer comprising the valve structure, and more specifically, relates to a valve structure of an accumulator sprayer that can suppress reduction in spring force due to use and can exhibit higher pressure-accumulating performance than polypropylene springs, as well as to an accumulator sprayer comprising the valve structure.

### BACKGROUND ART

Today, an accumulator sprayer provided with a trigger for spraying liquid are widely known.

This accumulator spray is configured to increase the pressure of the liquid inside a cylinder by pulling back the trigger and sliding a piston against the cylinder, and then to forcefully spray the liquid inside the cylinder out of the nozzle when the pressure exceeds a certain level.

More specifically, the cylinder is located between two one-way valves (i.e. a first valve and a second valve), and when the accumulated pressure of the liquid in the cylinder, which has been introduced via the first valve, exceeds a certain level, a space between a valve body and a valve seat of the second valve is released and the valve is opened, then the liquid is forcefully pushed out of the cylinder and sprayed outwards via the nozzle.

In this case, the valve body of the second valve is always pressed against the valve seat by the resilient force of a spring, and when the fluid pressure inside the cylinder exceeds the resilient force in a state in which the first valve is closed, the second valve opens and the fluid passes through forcefully.

When the liquid is sprayed from the nozzle and the pressure inside the cylinder is released, the resilient force becomes stronger than the liquid pressure, and the spring presses the valve body against the valve seat, causing the second valve to close again.

The accumulator sprayer including the trigger is useful because it can forcefully splay the liquid in the cylinder to the outside in this manner.

As for such accumulator sprayer, for example, several types have been developed by the applicant.

For example, the invention in PTL 1 is a trigger sprayer for sucking up and splay liquid in a container, and has a second valve that opens and closes according to the pressure of the liquid, and the second valve has a second valve piston portion and an inverted-dome-shaped dome spring portion for applying force to the second valve piston portion.

The invention of PTL 2 is similar.

### CITATION LIST

### Patent Literature

PTL 1: Japanese Patent Application No. 2020-219863

PTL 2: Japanese Patent Application No. 2020-219864

### SUMMARY OF INVENTION

### Technical Problem

In sprayers where the valve body and spring are integrated, as in the inventions described in PTL 1 and PTL 2, synthetic resin is employed as the material for both the valve body and spring.

In this case, if the accumulator sprayer is used for a long time and the trigger is operated many times, the synthetic resin that serves as the spring will be put under strain.

Accumulation of this stress leads to plastic deformation in the synthetic resin, causing a reduction in spring force and preventing it from exhibiting sufficient spring force.

Moreover, due to the characteristics of synthetic resin, it is difficult for the spring to exhibit a pressure-accumulating force exceeding a certain level.

Specifically, achieving greater spring force requires the synthetic resin to be made more rigid, however, increasing the rigidity of the synthetic resin reduces the range of movement of the valve body, hindering the opening and closing of the valve.

Consequently, it is difficult to achieve the high pressure-accumulating performance necessary for spraying a larger volume of liquid.

Here, high pressure-accumulating performance means that the valve opens at high pressure, that the valve body moves sufficiently to open the fluid flow path wide, and that the valve closes quickly when the fluid is sprayed out.

The present invention was developed in response to the above-mentioned problem.

That is, the purpose of the present invention is to provide a valve structure of an accumulator sprayer that can suppress the reduction in spring force even when the trigger is operated many times, and further can demonstrate high pressure-accumulating performance, as well as to provide an accumulator sprayer provided with the valve structure.

### Solution to Problems

The present inventors have conducted extensive research and has found that the above problem can be solved by providing a spring portion and a valve piston portion, which functions as a valve body, separately within a valve structure, making the spring portion to press the valve piston portion in vertical direction, and making the spring portion to possess higher rigidity than conventional valve piston portions. The present invention is based on this finding.

The present invention resides in a valve structure that is used by attaching to a sub-cylinder portion of an accumulator sprayer provided with a cylinder body portion having a main cylinder portion and the sub-cylinder portion, and a cover portion that is attached to cover the cylinder body portion, wherein; the accumulator sprayer is attached to a container for sucking up liquid in the container through a first valve to the main cylinder portion, pressurizing the liquid in the main cylinder portion, and spraying the liquid from a nozzle portion through the valve structure when the pressure of the liquid reaches a certain pressure; and the valve structure comprises a spring portion and a valve piston portion provided separately from the spring portion, wherein the valve piston portion is provided with a spring attaching portion, the spring portion is attached to the spring attaching portion, the spring portion presses the valve piston portion in vertical direction, and the spring portion has higher rigidity than the valve piston portion.

The present invention resides in the valve structure described above, wherein the spring portion is formed of metal, and the valve piston portion is formed of resin.

The present invention resides in the valve structure described above, wherein the spring portion is a coil spring formed of SUS (stainless steel).

The present invention resides in the valve structure described above, wherein the spring portion is a coil spring, the spring attaching portion comprises a base portion, a core rod portion provided upright on the base portion, and a corner portion connecting the base portion and the core rod portion, and the spring portion is placed on the base portion.

The present invention resides in the valve structure described above, wherein the spring portion has reverse dome shape, the spring attaching portion is provided with a base portion and a core rod portion provided upright on the base portion, and the spring portion is placed at the tip of the core rod portion.

The present invention resides in the valve structure described above, wherein the spring portion is provided with a top plate portion and a leaf spring portion that hangs down from the top plate portion, wherein the spring attaching portion has a bowl-shaped portion formed as bowl shape, and the leaf spring portion is placed on the bowl-shaped portion.

The present invention resides in the valve structure described above, wherein the spring portion is provided with a top plate portion, a wavy leaf spring portion that hangs down from the top plate portion, and a bottom plate portion provided at the tip of the leaf spring portion, wherein the spring attaching portion has tubular shape that is open at the top, and the bottom plate portion is placed on the spring attaching portion.

The present invention resides in an accumulator sprayer comprising the valve structure described above.

Furthermore, the present invention may also be provided with an appropriate combination of these elements.

### Advantageous Effects of Invention

In the valve structure of the present invention, since the spring portion is attached to the spring attaching portion, the spring portion, which functions as a spring, and the valve piston portion, which functions as a valve body, can be made into separate parts.

Therefore, it is possible to make the spring portion and the valve piston portion have different characteristics in terms of rigidity.

In addition, since the spring portion presses the valve piston portion in vertical direction and the spring portion has higher rigidity than the valve piston portion, the spring portion can sufficiently press the valve piston portion, and it is possible to demonstrate high pressure-accumulating performance.

In the valve structure of the present invention, since the spring portion is formed of metal, and the valve piston portion is formed of resin, the spring portion can sufficiently press the valve piston portion.

In the valve structure of the present invention, since the spring portion is a coil spring formed of SUS, the return force of the spring portion can be improved, and when the liquid pressure in the second valve decreases due to the liquid being sprayed from the nozzle portion, the spring portion immediately presses the valve piston portion to close the second valve.

This makes the accumulator sprayer provided with the valve structure more responsive.

Here, responsiveness refers to the fact that, in the accumulator sprayer, when the pulling of the trigger portion is stopped, the valve immediately closes and the liquid spraying stops.

In addition, since the spring portion is the coil spring, it is easy to change the spring force of the spring portion, making it possible to easily change the responsiveness of the accumulator sprayer.

In the valve structure of the present invention, since the spring attaching portion comprises a base portion and a core rod portion provided upright on the base portion, the spring portion can be properly positioned and press the valve piston portion.

Therefore, the spring portion can demonstrate sufficient pressing force.

In addition, since the corner portion connecting the base portion and the core rod portion is provided, the spring portion comes into contact with the corner portion and the positioning of the spring portion is carried out, and the spring force of the spring portion is evenly applied to the valve piston portion.

This ensures that the second valve closes accurately, and also improves the responsiveness of the accumulator sprayer.

In addition, since the spring is the coil spring, the spring force of the spring portion can be easily changed, and the responsiveness of the accumulator sprayer can be easily changed.

In the valve structure of the present invention, since the spring portion has reverse dome shape, the return speed of the spring portion is increased, and when the pulling of the trigger portion is stopped, the second valve is immediately closed.

As a result, the responsiveness is improved.

In addition, since the spring attaching portion is provided with the base portion and the core rod portion provided upright on the base portion, and the spring portion is placed at the tip of the core rod portion, the spring portion can press the valve piston portion without bias.

Therefore, the opening and closing of the second valve is stabilized, and, as a result, the spraying of the liquid by the accumulator sprayer is stabilized.

In the valve structure of the present invention, since the spring portion is provided with the top plate portion and a leaf spring portion that hangs down from the top plate portion, the spring attaching portion has a bowl-shaped portion formed as bowl shape, and the leaf spring portion is placed on the bowl-shaped portion, the spring portion can press the valve piston portion without bias.

Therefore, the opening and closing of the second valve is stabilized, and, as a result, the spraying of the liquid by the accumulator sprayer is stabilized.

In the valve structure of the present invention, since the spring portion is provided with the top plate portion, the wavy leaf spring portion that hangs down from the top plate portion, and the bottom plate portion provided at the tip of the leaf spring portion, wherein the spring attaching portion has tubular shape that is open at the top, and the bottom plate portion is placed on the spring attaching portion, the spring force exerted by the spring portion is transmitted in a two-dimensional manner at the top and bottom of the spring portion.

Therefore, the spring portion can press the valve piston portion without bias.

Therefore, the opening and closing of the second valve is stabilized, and, as a result, the spraying of the liquid by the accumulator sprayer is stabilized.

In the accumulator sprayer of the present invention, since it comprises the valve structure described above, high pressure-accumulating performance can be realized.

### BRIEF DESCRIPTION OF DRAWING

FIG. 1 is a sectional view showing an accumulator sprayer according to the first embodiment.

FIG. 2 is an enlarged sectional view showing a valve structure shown in FIG. 1.

FIG. 3 is a perspective view showing a valve piston portion according to the first embodiment.

FIG. 4 is a perspective view showing a spring portion according to the first embodiment.

FIG. 5 is an explanatory drawing showing an inner circumferential wall of the sub-cylinder portion.

FIG. 6 is an enlarged sectional view showing a valve structure according to the second embodiment.

FIG. 7 is a perspective view showing a valve piston portion according to the second embodiment.

FIG. 8 is a perspective view showing a spring portion according to the second embodiment.

FIG. 9 is an enlarged sectional view showing a valve structure according to the third embodiment.

FIG. 10 is a perspective view showing a valve piston portion according to the third embodiment.

FIG. 11 is a perspective view showing a spring portion according to the third embodiment.

FIG. 12 is an enlarged sectional view showing a valve structure according to the fourth embodiment.

FIG. 13 is a perspective view showing a valve piston portion according to the fourth embodiment.

FIG. 14 is a perspective view showing a spring portion according to the fourth embodiment.

### DESCRIPTION OF EMBODIMENTS

Hereinafter, preferred embodiments of the present invention will be described in detail with reference to the drawing as necessary.

Note that, in the drawings, the same components are provided with the same reference numeral and redundant description is omitted.

In addition, unless otherwise specified, positional relationships such as up, down, left, right will be based on the positional relationships shown in the drawing. Furthermore, the dimensional ratios of the drawing are not limited to those shown in the drawing.

### First Embodiment

The accumulator sprayer X of the present invention is attached to a container J, sucks up liquid in the container J into a main cylinder portion B1 via a first valve FV, applies pressure to the liquid in the main cylinder portion B1, and when the liquid pressure exceeds a certain pressure, the liquid is sprayed forcefully from a nozzle portion F through the valve structure A.

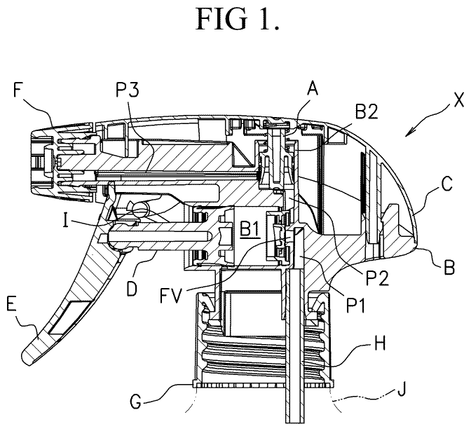

FIG. 1 is a sectional view showing an accumulator sprayer X according to the first embodiment.

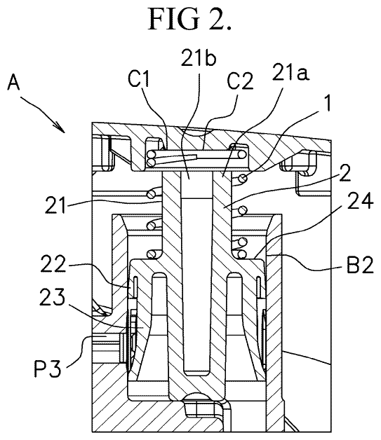

In addition, FIG. 2 is an enlarged sectional view showing a valve structure A shown in FIG. 1.

The accumulator sprayer X includes the nozzle portion F, a cylinder body portion B (including the main cylinder portion B1, a sub-cylinder portion B2, a first passage portion P1, a second passage portion P2, and a third passage portion P3, etc.), a piston portion D, a cover portion C, a trigger portion E, the first valve FV, a second valve, an introduction tube H, a trigger-returning spring I, and a cap portion G.

The cylinder body portion B is a portion that has a passage through which the liquid flows, and includes the main cylinder portion B1 for accommodating the piston portion D, the first passage portion P1 for introducing the liquid from the container J into the main cylinder portion B1, the second passage portion P2 for introducing the liquid from the main cylinder portion B1 into the sub-cylinder portion B2 to which the valve structure A is attached, and the third passage portion P3 for introducing the liquid from the sub-cylinder portion B2 into the nozzle portion F.

The introduction tube H is cylindrical shape and is fitted below the cylinder body portion B.

The introduction tube H is connected to the main cylinder portion B1 via the first passage portion P1.

The main cylinder portion B1 is a cylindrical shaped member. The piston portion D that slides inside the main cylinder portion B1 in conjunction with the movement of the trigger portion E is inserted in the main cylinder portion B1.

The first valve FV is provided between the main cylinder portion B1 and the first passage portion P1.

The first valve FV is a one-way valve that allows the liquid to pass from the first passage portion P1 into the main cylinder portion B1.

The main cylinder portion B1 is connected to the sub-cylinder portion B2 via the second passage portion P2.

The sub-cylinder portion B2 is formed in a cylindrical shape whose top is open. The valve structure A is attached to the sub-cylinder portion B2. Specifically, the bottom portion of the sub-cylinder portion B2 is a lower support portion B23 which supports the valve structure A, and the valve structure A is placed on the lower support portion B23.

Here, as described below, the inner wall of the sub-cylinder portion B2 functions as the valve seat, and the valve piston portion 2 of the valve structure A, more specifically an inner skirt portion 23, functions as the valve body, thereby so-called second valve is formed.

On the nozzle portion F side of the sub-cylinder portion B2, a longitudinal groove portion B21 and a through hole B22, which will be described later, are provided, and the through hole B22 is contact with the third passage portion P3.

Note that a flange portion is provided at a lower end of the cylinder body portion B (see FIG. 1), and by sandwiching this flange portion by the upper end portion of the container J and the cap portion G, the accumulator sprayer X is fixed to the container J.

The cover portion C is mounted so as to cover the entire cylinder body portion B.

In the condition that the cover portion C is attached to the cylinder body portion B, a space is created between the cover portion C and the sub-cylinder portion B2 of the cylinder body portion B, and the valve structure A is attached in the space.

An upper support portion C1 is provided in the cover portion C for supporting the valve structure A.

This upper support portion C1 is a portion of the inner upper wall of the cover portion C that supports the upper end of the spring portion 1.

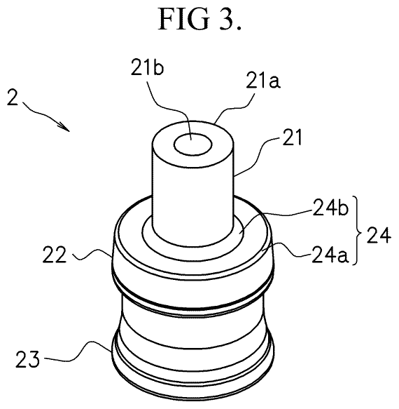

FIG. 3 is a perspective view showing a valve piston portion 2 according to the first embodiment.

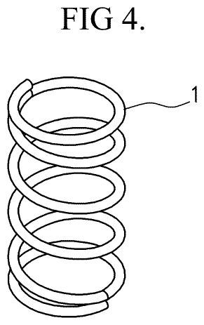

In addition, FIG. 4 is a perspective view showing a spring portion according to the first embodiment.

When the valve piston portion 2 moves upward, the spring portion 1 contacts with the upper support portion C1 as shown in FIG. 4. Furthermore, the valve piston portion 2 moves upward and the spring portion 1 deforms, thereby pressing force is applied against the valve piston portion 2.

The valve structure A comprises a spring portion 1 and the valve piston portion 2 provided separately from the spring portion.

The valve piston portion 2 has a base portion 24a, and a cylindrical core rod portion 21 is erected upward from the base portion 24a at an approximately center position of the base portion 24a.

The base portion 24a also has a corner portion 24b that connects the base portion 24a and the core rod portion 21.

The core rod portion 21, the base portion 24a and the corner portion 24b composes the spring attaching portion 24.

Specifically, the core rod portion 21 is inserted into the coiled spring portion 1 from its bottom, and the spring portion 1 is placed on the base portion 24a, thereby the spring portion 1 and the valve piston portion 2 are attached.

Since the spring attaching portion 24 is composed of the base portion 24a and the corner portion 24b, and the spring portion 1 is positioned by abutting against the corner portion 24b, the spring portion 1 can press the valve piston portion 2 in a properly positioned state.

As a result, the spring portion 1 can exert sufficient pressing force, and high pressure-accumulation performance can be achieved.

In addition, since the spring portion 1 is positioned by abutting against the corner portion 24b, the spring force of the spring portion 1 is evenly applied to the valve piston portion. This ensures that the second valve is properly closed and improves the responsiveness of the accumulator sprayer X.

In the valve piston portion 2, an outer skirt portion 22 extending downward continuously from the area around the base portion 24a is formed.

Furthermore, a skirt portion extending downward longer than the outer skirt portion 22 is formed inside the outer skirt portion 22.

That is, the core rod portion 21, the outer skirt portion 22 and the inner skirt portion 23 forms the valve piston portion 2.

Since the coil spring, spring portion 1, is attached to the spring attaching portion 24, the resilient force of the spring portion 1 is applied evenly to the valve piston portion 2.

Therefore, the pressing force caused by the spring portion 1 can be transmitted properly, the axial center of the valve piston portion 2 is stabilized, and lateral movement during vertical movement is prevented.

In addition, since the spring portion 1 is coil spring, it is easy to change the spring force of the spring portion 1, making it possible to easily change the responsiveness of the accumulator sprayer X.

As a material of the spring portion 1, a material with excellent rigidity, specifically, SUS, hard steel wire (SWC), piano wire etc. can be used preferably. In particular, a spring portion 1 made of SUS is preferable from the perspective of corrosion resistance and heat resistance.

By using these materials, the return force of the spring portion 1 can be improved, and when the liquid pressure in the second valve decreases due to the liquid being sprayed from the nozzle portion, the spring portion 1 immediately presses the valve piston portion 2 to close the second valve.

This makes the accumulator sprayer X provided with the valve structure A more responsive.

In addition, as a material of the valve piston portion 2, a synthetic resin material such as PP resin or polyethylene resin etc. is preferably used.

Since the materials of the spring portion 1 and the valve piston portion 2 are each designed so that the spring portion 1 has higher rigidity than the valve piston portion 2, and since the spring portion 1 presses the valve piston portion 2 in vertical direction, the spring portion 1 can sufficiently press the valve piston portion 2, and it is possible to demonstrate high pressure-accumulating performance.

In addition, in the accumulator sprayer X, since the core rod portion 21 is formed cylindrically between the spring portion 1 and the outer skirt portion 22, when the valve structure A moves vertically, there is no obstacle contacts with the wall surface of the sub-cylinder portion B2, thereby avoiding any obstruction to movement and allowing the opening and closing operations by the valve structure A to be performed smoothly.

Both the outer skirt portion 22 and the inner skirt portion 23 are formed in tapered shape, with their lower portion expanding outward.

As described later, the outer skirt portion 22 performs the sealing function, and the inner skirt portion 23 serves as a valve body.

The upper end of the core rod portion 21 is open and a center hole 21b is formed.

The periphery of the opened center hole 21b is convex and forms a tubular protrusion 21a.

That is, the center hole 21b and the tubular protrusion 21a are formed in approximately center of the spring portion 1.

As mentioned later, the tubular protrusion 21a serves as a stopper of the valve structure A, which functions as a valve body.

In the accumulator sprayer X, since the center hole 21b whose top is open is formed in the valve piston portion 2, the weight of the valve structure A can be reduced.

In addition, axial bending is prevented when the valve structure A is pressed.

In the accumulator sprayer X, the valve structure A is attached to the sub-cylinder portion B2. As mentioned above, the sub-cylinder portion B2 is formed in a cylindrical shape whose top is open, and the valve structure A is attached so that the outer skirt portion 22 and the inner skirt portion 23 press the inner wall of the sub-cylinder portion B2.

At this time, the valve structure A is placed on the lower support portion B23 formed at the bottom portion of the sub-cylinder portion B2.

The spring portion 1 is supported by the upper support portion C1 of the cover portion C.

The upper support portion C1 of the cover portion C is a portion to which the spring portion 1 contacts in the inner wall of the cover portion C.

In the cover portion C, a convex stopper portion C2 is provided at a position corresponding to the tubular protrusion 21a.

The stopper portion C2 is provided for restricting the upward movement of the valve structure A.

In addition, a groove is formed in a ring shape around the stopper portion C2 on the upper support portion C1, so that the spring portion 1 can be in contact with it.

As a result, the stopper portion C2 contacts the core rod portion 21 to restrict upward movement of the valve piston portion 2, while the spring portion 1 fits into the groove and deforms, thereby exerting sufficient pressing force on the valve piston portion 2.

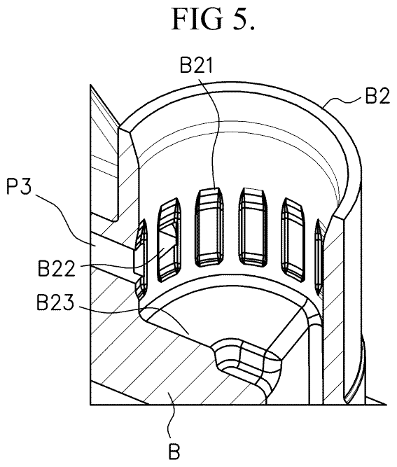

FIG. 5 is an explanatory drawing showing an inner circumferential wall of the sub-cylinder portion B2.

In the inner circumferential wall of the sub-cylinder portion B2, a plurality of concave longitudinal groove portions B21 are provided extending vertically in all directions and at regular intervals.

Of these, at the bottom of the longitudinal groove portion B21 provided at the position corresponding to the third passage portion P3 located on the nozzle portion F side, the through hole B22 contacting with the third passage portion P3 is provided. No thorough holes B22 are provided in the vertical groove portions B21 other than those corresponding to the nozzle portion F.

Between the vertical groove portions B21, the inner wall functions as a pillar.

As a result, when pressure is applied to the valve piston portion 2, the area around the longitudinal groove portion B21 is not deformed, and the valve piston portion 2 slides smoothly.

The third passage portion P3 is provided at a certain distance from the bottom portion of the sub-cylinder portion B2. Specifically, it is provided at a height of 2 to 3 mm from the bottom portion.

This causes a time lag from the time the trigger portion E is turned from the initial state and the valve piston portion 2 begins to move due to increased fluid pressure in the main cylinder portion B1 until the inner skirt portion 23 passes through the through hole B22 and the second valve opens.

Therefore, a state in which liquid is not sprayed out even when the trigger portion E is rotated (so-called “play”) is caused, thus the usability of the accumulator sprayer X is improved.

Here, referring to FIG. 1, the flow of the liquid when using the accumulator sprayer X to splay the liquid is explained.

The liquid flows in the following order: the container J, the introduction tube H, the first passage portion P1, the first valve FV, the main cylinder portion B1, the second passage portion P2, the sub-cylinder portion B2, the vertical groove portion B21 (the through hole B22), the third passage portion P3 and the nozzle portion F, and is sprayed from the nozzle portion F to outside.

In the initial state, the first valve FV and the second valve are closed, and the liquid is filled from the introduction tube H to the sub-cylinder portion B2.

The trigger portion E is not rotated.

When the trigger portion E is rotated, the piston portion D moves in the main cylinder portion B1 in conjunction with the trigger portion E, and the pressure in the main cylinder portion B1 is increased (accumulated).

At this time, the main cylinder portion B1 and the lower space of the valve piston portion 2 are connected via the second passage portion P2, and filled with the liquid.

When the liquid pressure increases sufficiently, the valve piston portion 2 moves upward as if pushed up by it, and the spring portion 1 is pressed and deformed.

When the valve structure A moves upward more due to the liquid pressure, the tubular protrusion 1A contacts with the stopper portion C2 as described above, thereby restricting the movement of the valve structure A.

Therefore, the valve structure A comes up to the upper dead point and the deformation of the spring portion 1 is suppressed within a certain range.

At this time, the spring portion 1 fits into the groove provided in the cover portion C and further deforms.

When the valve piston portion 2 rises sufficiently, the through hole B22 of the vertical groove portion B21 and the third passage portion P3 are connected, and the liquid moves into the nozzle portion F.

At this time, since the liquid is in a state of pressure-accumulated, it is sprayed forcefully from the nozzle portion F to outside.

Note that the first valve FV is closed in this time.

As the liquid is sprayed, the liquid pressure from the main cylinder portion B1 to the nozzle portion F decreases, and when the resilient force of the spring portion 1 overcomes this, the valve piston portion 2 is pushed down.

When the piston portion D is pushed down, the inner skirt portion 23 covers the third passage portion P3 and the second valve closes.

The trigger portion E is returned to its initial position by the spring force of the trigger-returning spring I.

In conjunction with the return of the trigger portion E, the piston portion D moves in the main cylinder portion B1, resulting in negative pressure in the main cylinder portion B1 and opening the first valve FV.

At this time, since there is a connection from the container J to the inside of the main cylinder portion B1, the liquid is sucked up by the negative pressure, from the container J into the main cylinder portion B1 through the introduction tube H and the first passage portion P1.

When the negative pressure in the main cylinder portion B1 is eliminated by the inflow of the liquid, the first valve FV closes and the liquid movement stops.

At this time, the second valve (the valve structure A) is in the closed state as described above.

Therefore, the accumulator sprayer X returns to the initial state.

At this time, both the first valve FV and the second valve are closed, and the liquid is filled from the introduction tube H to the sub-cylinder portion B2.

Note that, for the material of the cylinder body portion B comprising the main cylinder portion B1 and sub-cylinder portion B2, PP resin (polypropylene resin) or the like is preferably used.

Since the valve structure A according to the present embodiment is provided to the accumulator sprayer X, high pressure-accumulating performance can be realized.

### Second Embodiment

The second embodiment of the present invention is described below. The parts that overlap with the first embodiment are omitted.

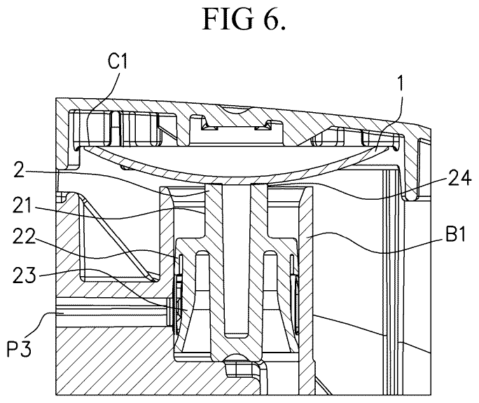

FIG. 6 is an enlarged sectional view showing a valve structure according to the second embodiment.

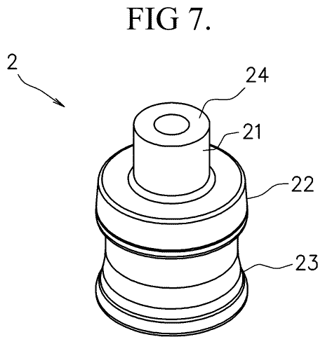

In addition, FIG. 7 is a perspective view showing a valve piston portion according to the second embodiment.

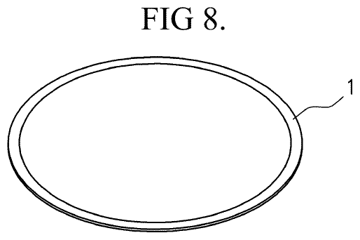

In addition, FIG. 8 is a perspective view showing a spring portion according to the second embodiment.

In the second embodiment, the spring portion 1 has reverse dome shape, and the spring attaching portion 24 is provided with a base portion 24a and a core rod portion 21 provided upright on the base portion 24a, and the spring portion 1 is placed at the tip of the core rod portion 21, thereby the spring portion 1 is attached to the valve piston portion 2.

In the second embodiment, since the spring portion 1 and the valve piston portion 2 are both uniform in the circumferential direction, the spring portion 1 can press the valve piston portion 2 without bias.

Therefore, the opening and closing of the second valve is stabilized, and, as a result, the spraying of the liquid by the accumulator sprayer X is stabilized.

In addition, since the spring portion 1 has reverse dome shape, the return speed of the spring portion 1 is increased, and when the pulling of the trigger portion E is stopped, the second valve is immediately closed.

As a result, the responsiveness is improved.

### Third Embodiment

The third embodiment of the present invention is described below.

The parts that overlap with the first and second embodiments are omitted.

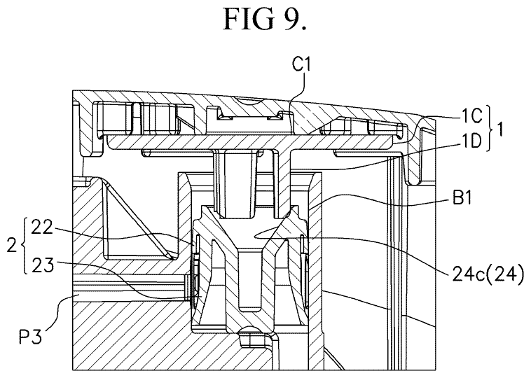

FIG. 9 is an enlarged sectional view showing a valve structure according to the third embodiment.

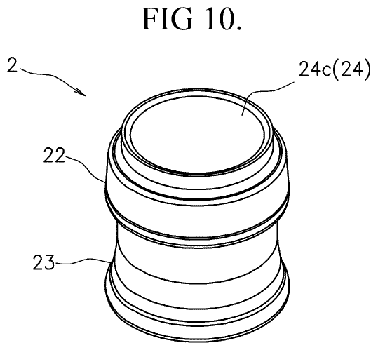

FIG. 10 is a perspective view showing a valve piston portion 2 according to the third embodiment.

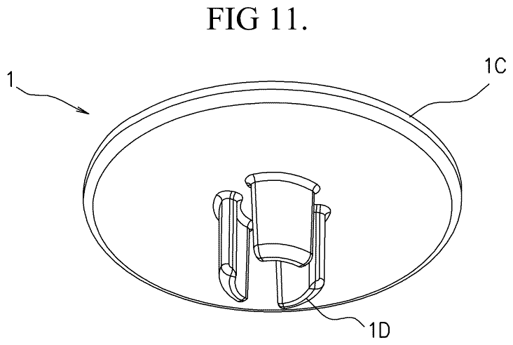

FIG. 11 is a perspective view showing a spring portion 1 according to the third embodiment.

In the third embodiment, the spring portion 1 is provided with a top plate portion 1C and a leaf spring portion 1D that hangs down from the top plate portion 1C.

In addition, the spring attaching portion 24 has a bowl-shaped portion 24c formed as bowl shape, and the leaf spring portion 1D is placed on the bowl-shaped portion 24c, thereby the spring portion 1 is attached to the valve piston portion 2.

The top plate portion 1C is in contact and pressed by the upper support portion C1 in two-dimensional manner.

In addition, since the leaf spring portion 1D presses the bowl-shaped portion 24c, the spring portion 1 can press the valve piston portion 2 without bias.

Therefore, the opening and closing of the second valve is stabilized, and, as a result, the spraying of the liquid by the accumulator sprayer X is stabilized.

In the third embodiment, POM resin is preferably used for the spring portion 1.

This makes it possible for the spring portion 1 to have higher rigidity than that of a spring made of polypropylene resin.

In addition, it is possible to manufacture the spring portion 1 by injection molding.

In addition, the valve piston portion 2 is the same as in the first embodiment.

### Fourth Embodiment

The fourth embodiment of the present invention is described below.

The parts that overlap with the first, second and third embodiments are omitted.

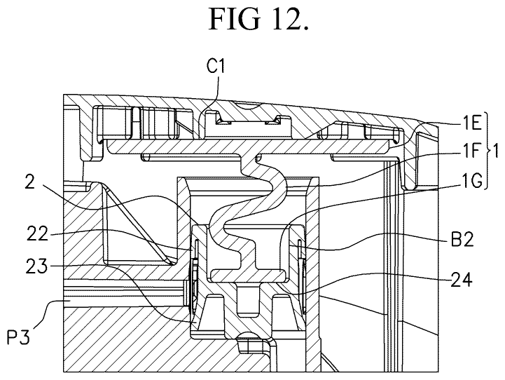

FIG. 12 is an enlarged sectional view showing a valve structure A according to the fourth embodiment.

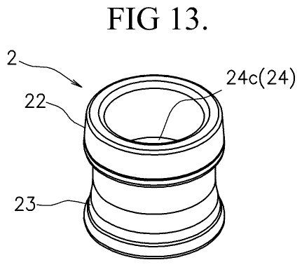

In addition, FIG. 13 is a perspective view showing a valve piston portion 2 according to the fourth embodiment.

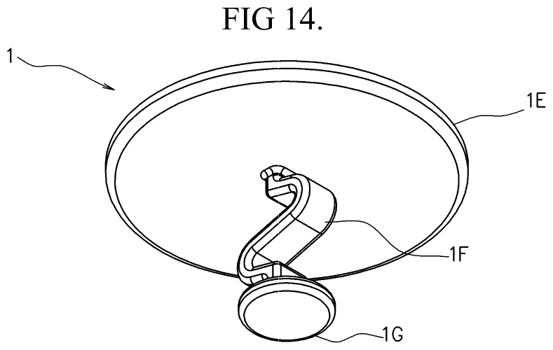

In addition, FIG. 14 is a perspective view showing a spring portion 1 according to the fourth embodiment.

In the fourth embodiment, the spring portion 1 is provided with a top plate portion 1E, a wavy leaf spring portion 1F that hangs down from the top plate portion 1E, and a bottom plate portion 1G provided at the tip of the leaf spring portion.

The spring attaching portion 24 has tubular shape that is open at the top, and the bottom plate portion 1G is placed on the spring attaching portion 24, thereby the spring portion 1 is attached to the valve piston portion 2.

The top plate portion 1E is in contact with the upper support portion C1 in two-dimensional manner.

The bottom plate portion 1G is also in contact with the valve piston portion 2 in two-dimensional manner.

Therefore, the spring force exerted by the spring portion 1 is transmitted at the top (top plate portion E) and bottom (bottom plate portion 1G) of the spring portion 1 in two-dimensional manner.

Therefore, the spring portion 1 can press the valve piston portion 2 without bias.

Therefore, the opening and closing of the second valve is stabilized, and, as a result, the spraying of the liquid by the accumulator sprayer X is stabilized.

In the fourth embodiment, POM resin is preferably used for the spring portion 1.

This makes it possible for the spring portion 1 to have higher rigidity than that of a spring made of polypropylene resin.

In addition, it is possible to manufacture the spring portion 1 by injection molding.

The preferred embodiments of the present invention have been described above; however, the present invention is not limited to these embodiments.

The shapes of the spring portion 1 and the valve piston portion 2 are not limited to the above embodiments, and any appropriate shape may be employed, provided that the spring portion 1 can press the valve piston portion 2.

### INDUSTRIAL APPLICABILITY

The valve structure A of the present invention can be suitably used in the accumulator sprayer X provided with the trigger.

Furthermore, the accumulator sprayer X provided with the valve structure A of the present invention can demonstrates high pressure-accumulating performance, and can be widely used for liquid spraying.

### REFERENCE SIGNS LIST

X . . . accumulator sprayer
A . . . valve structure
1 . . . spring portion
1C, 1E . . . top plate portion
1D, 1F . . . leaf spring portion
1G . . . bottom plate portion
2 . . . valve piston portion
21 . . . core rod portion
21a . . . tubular protrusion
21b . . . central hole
22 . . . outer skirt portion
23 . . . inner skirt portion
24 . . . spring attaching portion
24a . . . base portion
24b . . . corner portion
24c . . . bowl-shaped portion
B . . . cylinder body portion
B1 . . . main cylinder portion
B2 . . . sub-cylinder portion
B21 . . . vertical groove portion
B22 . . . through hole
B23 . . . lower support portion
C . . . cover portion
C1 . . . upper support portion
C2 . . . stopper portion
D . . . piston portion
E . . . trigger portion
F . . . nozzle portion
G . . . cap portion
H . . . introduction tube
I . . . trigger-returning spring
J . . . container
FV . . . first valve
P1 . . . first passage portion
P2 . . . second passage portion
P3 . . . third passage portion

1. A valve structure that is used by attaching to a sub-cylinder portion of an accumulator sprayer provided with a cylinder body portion having a main cylinder portion and the sub-cylinder portion, and a cover portion that is attached to cover the cylinder body portion, wherein;
the accumulator sprayer is attached to a container for sucking up liquid in the container through a first valve to the main cylinder portion, pressurizing the liquid in the main cylinder portion, and spraying the liquid from a nozzle portion through the valve structure when the pressure of the liquid reaches a certain pressure; and
the valve structure comprises a spring portion and a valve piston portion provided separately from the spring portion, wherein
the valve piston portion is provided with a spring attaching portion,
the spring portion is attached to the spring attaching portion,
the spring portion presses the valve piston portion in vertical direction, and
the spring portion has higher rigidity than the valve piston portion.

2. The valve structure according to claim 1, wherein
the spring portion is formed of metal, and
the valve piston portion is formed of resin.

3. The valve structure according to claim 2, wherein the spring portion is a coil spring formed of SUS.

4. The valve structure according to claim 1, wherein
the spring portion is a coil spring,
the spring attaching portion comprises a base portion, a core rod portion provided upright on the base portion, and a corner portion connecting the base portion and the core rod portion, and
the spring portion is placed on the base portion.

5. The valve structure according to claim 1, wherein
the spring portion has reverse dome shape,
the spring attaching portion is provided with a base portion and a core rod portion provided upright on the base portion, and
the spring portion is placed at the tip of the core rod portion.

6. The valve structure according to claim 1, wherein
the spring portion is provided with a top plate portion and a leaf spring portion that hangs down from the top plate portion, wherein
the spring attaching portion has a bowl-shaped portion formed as bowl shape, and
the leaf spring portion is placed on the bowl-shaped portion.

7. The valve structure according to claim 1, wherein
the spring portion is provided with a top plate portion, a wavy leaf spring portion that hangs down from the top plate portion, and a bottom plate portion provided at the tip of the leaf spring portion,
the spring attaching portion has tubular shape that is open at the top, and
the bottom plate portion is placed on the spring attaching portion.

8. An accumulator sprayer comprising the valve structure according to claim 1.
